(19) United States
(12) Patent Application Publication
(10) Pub. No.: US 2008/0147561 A1
(43) Pub. Date: Jun. 19, 2008

(54) Image based invoice payment with digital signature verification

(75) Inventors: James A. Euchner, Waccabuc, NY (US); Thomas J. Foth, Trumbull, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/641,470

(22) Filed: Dec. 18, 2006

(51) Int. Cl. H04L 9/32; G06Q 20/00; H04L 9/30

(52) U.S. Cl. 705/64; 705/71

(57) ABSTRACT

A method of processing the payment of an invoice received by a billee includes receiving an electronic image of the invoice and payment information, including a payment amount, relating to the invoice from the billee, and generating a signed payment data element that includes a first portion including the electronic image, at least a portion of the payment information including at least the payment amount, and OCR data obtained from the electronic image, and a second portion that includes a digital signature of the first portion generated using a private key of a payment system of the billee's bank. The signed payment data element is transmitted to the billee so that it may be associated with the invoice.

### FIELD OF THE INVENTION

The present invention relates to electronic bill payment, and in particular to image based invoice payment methods that include digital signature verification.

### BACKGROUND OF THE INVENTION

The payment of invoices or similar bills by a business enterprise typically requires a significant amount of manual handling. In particular, during the course of processing the payment of invoices, a clerk or other employee of the party that received the invoices (hereinafter referred to as a billee) often has to enter information into one or more computer systems that produce checks for paying the invoices and that accumulate accounts payment information relating to the paid invoices. In addition, the same or a different employee also typically marks as paid and files the invoices that were processed for payment. All of these steps are both labor intensive and time consuming.

Moreover, in the manual process described above, there is no mechanism to reliably and objectively show that instructions to pay a certain invoice were provided on a particular date. As will be appreciated, this would be helpful should a dispute or question regarding payment of an invoice arise. Thus, there is a need for improved invoice payment methods that reduce the amount of manual labor required that is required and that provide some form of reliable verification that instructions for paying the invoices have been provided.

### SUMMARY OF THE INVENTION

In one embodiment, the invention provides a method of processing the payment of an invoice received by a billee that includes receiving from the billee (i) an electronic image of the invoice and (ii) payment information relating to the invoice that includes a payment amount to be paid against the invoice. The method further includes generating a signed payment data element that includes a first portion and a second portion. The first portion of the signed payment data element includes the electronic image of the invoice, at least a portion of the payment information including at least the payment amount, and OCR data obtained from the electronic image of the invoice through optical character recognition. The second portion of the signed payment data element includes a digital signature of the first portion generated using a private key of a payment system of the billee's bank. The method further includes transmitting the signed payment data element to the billee so that it may be associated with the invoice.

The method may further include storing the signed payment data element for subsequent access by the payment system. In addition, the method may still further include generating a transaction identifier, such as a serial number, after the receiving step, wherein the transaction identifier is associated with the invoice. In such a case, the first portion of the signed payment data element further includes the transaction identifier.

The OCR data that is included in the signed payment data element preferably includes a name and address of a biller associated with the invoice and an amount due for the invoice. The OCR data may be generated by and received from the billee or, alternatively, may be generated by the payment system after the electronic image of the invoice is received from the billee.

The payment information received from the billee may further include one or more of a method of payment for the invoice, an identifier of a person authorized by the billee to make a payment for the invoice, a transmission date and time, a terminal ID for the scanning device, a location identifier of the scanning device (such as an address of the billee location at which it is located), the TCP/IP address used by the scanning device for the transmission, and/or the telephone number used by the scanning device for the transmission. Such payment information may also be included in the first portion of the signed payment data element.

The method also preferably further includes causing a payment to be made to a biller associated with the invoice in an amount equal to the payment amount. The payment may be made by way of an electronic funds transfer to the biller, a physical check sent to the biller, or a credit card charge to be credited to the biller. The method may also further include determining whether the billee has sufficient funds to make a payment to the biller associated with the invoice in the requested amount (the payment amount). In this embodiment, the generating and transmitting steps are performed only if it is determined that the billee has the sufficient funds.

Preferably, the signed payment data element is transmitted to the billee in a machine readable form that may be physically associated with the invoice. For example, the machine readable form may be a barcode that may be printed on the invoice.

In another embodiment, the invention provides a method of arranging payment of an invoice received by a billee that includes generating an electronic image of the invoice and transmitting at least the electronic image and payment information relating to the invoice to a payment system of a bank of the billee. As in the embodiments described above, the payment information includes a payment amount to be paid against the invoice. The method further includes receiving a signed payment data element from the payment system that includes a first portion and a second portion. The first portion includes the electronic image of the invoice, at least a portion of the payment information including at least the payment amount, and OCR data obtained from the electronic image of the invoice through optical character recognition. The second portion includes a digital signature of the first portion generated using a private key of the payment system. The method also includes associating the signed payment data element with the invoice. The payment system causes a payment to be made to a biller associated with the invoice in an amount equal to the payment amount.

The associating step may include printing the signed payment data element on the invoice. For example, the receiving step may include receiving the signed payment data element in a machine readable form, such as a barcode, and the printing step may include printing the barcode on the invoice.

The OCR data may be generated at a billee location, in which case the transmitting step further includes transmitting the OCR data from the billee location to the payment system. Alternatively, the OCR data may be generated by the payment system from the received electronic image of the invoice.

The first portion of the signed payment data element may further include a transaction identifier associated with the invoice that is generated by the payment system following receipt of the electronic image and the payment information from the billee. In addition, the payment information may include one or more of a method of payment for the invoice, an identifier of a person authorized by the billee to make a payment for the invoice, a transmission date and time, a terminal ID for the scanning device, a location identifier of the scanning device (such as an address of the billee location at which it is located), the TCP/IP address used by the scanning device for the transmission, and/or the telephone number used by the scanning device for the transmission.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of a system for implementing the image based invoice payment methods that include digital signature verification according to the embodiments described herein; and

FIGS. 2 and 3 are a flowchart of one particular embodiment of an image based invoice payment method that includes digital signature verification according to the present invention.

### DESCRIPTION OF THE PREFERRED EMBODIMENTS

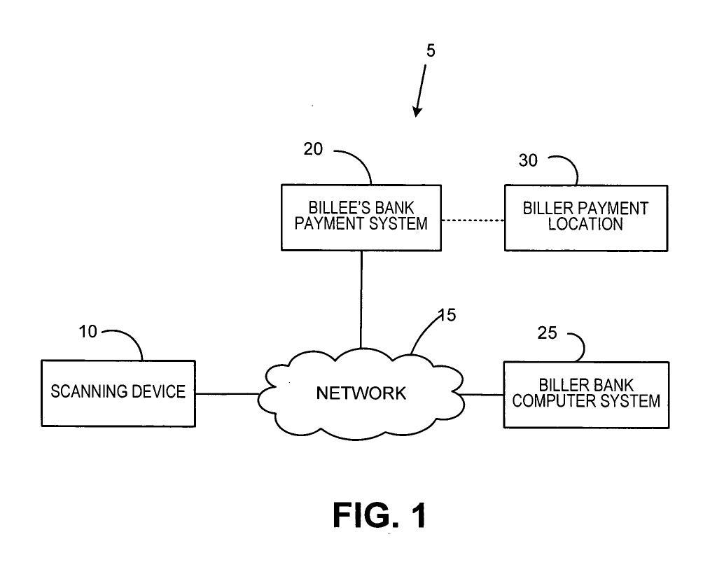

FIG. 1 is a block diagram of a system 5 for implementing an image based invoice payment method that includes digital signature verification according to the embodiments of the present invention described herein. The system 5 includes a scanning device 10 which is located at a billee location. The scanning device 10 preferably includes a processing unit, a memory and a digital scanner that is able to create electronic images of a document such as an invoice received by the billee. The scanning device 10 is also specifically designed or adapted, typically through software provided therewith, to provide the functionality described herein. For that purpose, the scanning device 10 is provided with optical character recognition software that is able to obtain from an electronic image of an invoice certain information that is provided thereon (described in greater detail herein). A number of suitable scanning devices (that may be adapted as described herein) are known and are commercially available and may include, for example, the TS220E scanner sold by Digital Check Corporation of Northfield, Ill.

The scanning device 10 is in secure electronic communication with a network 15, which may be, for example, the Internet, or one or more private computer networks, or any combination thereof. The system 5 also includes a bank payment system 20 that is operated by or under the direction of the billee's bank. The billee's bank payment system 20 comprises a decision system that is, among other things, able to cause payments to be made to specified third parties based upon instructions received from the billee. The billee's bank payment system 20 may be, for example, implemented by one or more server computers that are in secure electronic communication with the network 15. The billee's bank payment system 20 may, for example, and without limitation, cause payments to be made to third parties by way of (i) an electronic funds transfer through, for example, the ACH system or a similar suitable system, (ii) the generation and subsequent mailing of a check, or (iii) a charge to a credit card of the billee. Thus, the system 5 includes a biller bank computer system 25 that is in electronic communication with the network 15 for receiving electronic funds transfer and/or credit card transaction information. In addition, the system 5 includes a biller payment location 30 to which checks may be mailed by or at the direction of the billee's bank payment system 20.

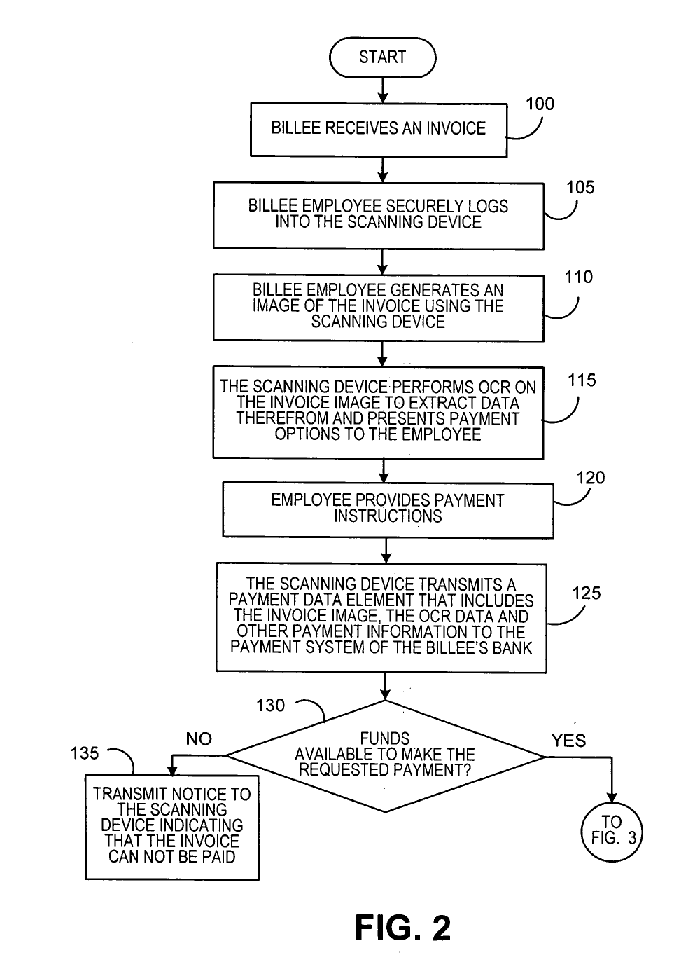

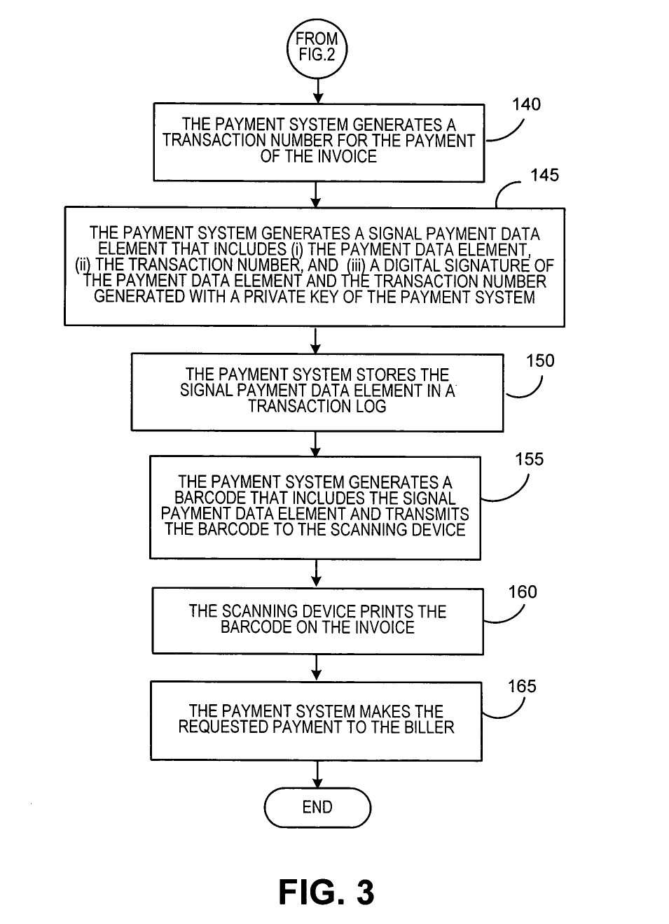

FIGS. 2 and 3 are a flowchart that illustrates a method of image-based bill payment with digital signature verification according to one embodiment of the invention. The method begins at step 100, where the billee receives an invoice from a biller for, for example, services rendered to the billee by the biller or products provided to the billee by the biller. At step 105, an employee of the billee responsible for making payments on invoices that are received securely logs into the scanning device 10 by, for example, providing a preset user ID or some other identifier and an associated pre-saved password, which logs the device 10 and the user onto the system. After the scanning device 10 verifies that the billee employee is authorized to use it for the purposes described herein (i.e., by verifying the user ID and password), the method proceeds to step 110, where the billee employee generates an electronic image of the invoice to be paid using the scanning device 10. Next, at step 115, the scanning device 10 performs optical character recognition (OCR) on the invoice image to extract certain data therefrom, which data preferably includes the name and address of the biller and the total amount owed that is indicated on the invoice. For this purpose, as described elsewhere herein, the scanning device 10 is provided with OCR software. As is known, such OCR software is commercially available from a number of commercial sources and will not be described further herein. Alternatively, if the invoice includes a barcode that includes the desired information, the desired information can be read from the barcode. In addition, in step 115, the scanning device 10 preferably presents certain payment options to the employee, such as through a display provided as part of the scanning device 10. Such payment options may include payment of the full amount due, payment of something less than the full amount due, or payment of more than the full amount due. In the preferred embodiment, the default payment option is payment of the full amount due.

Next, at step 120, the employee provides payment instructions to the scanning device, such as through an input device like a keyboard, a touch screen or the like that is provided as part of the scanning device 10. In particular, the employee may select to pay the full amount that is due from the options that are provided or, alternatively, may elect to key in an amount that is more or less than the full amount that is due. In any event, step 120 will result in receipt of a payment amount by the scanning device 10. In one embodiment, the method of paying the invoice (e.g., by electronic funds transfer, check or credit card) is set to a particular default mode that is subsequently used to actually pay the invoice. Alternatively, step 120 may optionally allow the employee to input a specified method of paying the invoice in question by selecting from a list of payment method options (it may, for example, allow the employee to override a pre-set default mode).

At step 125, the scanning device 10 transmits a payment data element to the billee's bank payment system 20 through the network 15. The payment data element preferably includes the invoice image that was created in step 110, the OCR data that was acquired in step 115, and certain other payment information which may include one or more of the payment amount that was specified in step 120, a payment method for the invoice (which may be the default method or the specific method that was optionally provided in step 120 as described above), the date and time of the transmission, the user ID that was provided in step 105, a terminal ID for the scanning device 10, a location identifier of the scanning device 10 (such as an address of the billee location at which it is located), the TCP/IP address used by the scanning device 10 for the transmission, and/or the telephone number used by the scanning device 10 for the transmission.

Next, at step 130, after the billee's bank payment system 20 receives the request including the payment data element from the scanning device 10, a determination is made as to whether the billee has sufficient funds available to make the requested payment. In the case of an electronic funds transfer or a check payment, this includes checking the relevant account of the billee for sufficient funds. In the case of a credit card payment, this involves checking the available credit on the specified card. As will be appreciated, other payment methods and other methods of checking funds availability are possible without departing from the scope of the present invention. If the answer at step 130 is no, meaning that sufficient funds are not available to make the requested payment, then at step 135, the billee's bank payment system 20 transmits a notice to the scanning device 10 that indicates that the invoice cannot be paid as requested. In this case, the scanning device 10 may eject the invoice and provide a notification of the inability to pay the invoice to the employee operating the scanning device 10 through, for example, a display provided as part of the scanning device 10. The employee may then decide to reprocess the invoice using a different payment method (such as through a different account or credit card), or may instead choose to process an invoice having a smaller amount due.

If, however, the answer at step 130 is yes, meaning that sufficient funds are available, then the method proceeds to step 140 (FIG. 3), wherein the billee's bank payment system 20 generates a transaction code or number for the payment of the invoice that uniquely identifies the invoice and the request to pay the invoice. The transaction number or code may include, for example, a serial number generated by the billee's bank payment system 20. Next, at step 145, the billee's bank payment system 20 generates a signed payment data element that preferably includes (i) the payment data element that was received from the scanning device 10, (ii) the transaction number generated in step 140, and (iii) a digital signature of the payment data element and the transaction number that is generated using a private key of the billee's bank payment system 20 using any suitable method of digital signature generation (the private key will, as is known in the art, correspond to a public key of the billee's bank payment system 20). Then, at step 150, the billee's bank payment system 20 stores the signed payment data element that was generated in step 145 in a transaction log or the like so that it may be later accessed. In an alternative embodiment, the signed payment data element may include just the payment data element and a digital signature thereof (in other words, in this embodiment, the transaction number is omitted).

Next, at step 155, the billee's bank payment system 20 generates a barcode, such as a two-dimensional barcode (for example, a Data Matrix barcode) that includes the signed payment data element and transmits the barcode to the scanning device 10 through the network 15. As an alternative to a barcode, some other type of machine readable format, such as XML, may be used without departing from the scope of the present invention. At step 160, after receiving the barcode (or, alternatively, some other machine readable element), the scanning device 10 prints the barcode on the invoice. In addition, at step 165, the billee's bank payment system 20 causes the requested payment to be made to the biller according to the appropriate method (e.g., electronic funds transfer, check, or credit card transaction).

Thus, the present method provides an intent verifying mechanism in the form of the signed payment data element that evidences that an authorized employee of the billee provided instructions to pay a particular invoice (an image of the invoice is included) in a particular amount on a particular date and/or time. In addition, because the signed payment data element is digitally signed, it provides evidence that the instructions were actually received by the billee's bank payment system. Thus, should it be necessary, the billee may use the signed payment data element (e.g., in barcode form) to prove that the billee instructed the payment system 20 to pay a particular invoice at a particular time and that such instructions were in fact received by the billee's bank payment system (as evidenced by the digital signature). The billee may also use the signed payment data element to determine which employee caused the payment to be made. In addition, according to a further aspect of the invention, the transaction number that is assigned to the invoice and the request to pay the invoice may be extracted from the signed payment data element (i.e., by reading the barcode) and may be used by the billee to access the billee's bank payment system 20 to track/determine whether the requested payment was actually made. For example, the billee could use the transaction number to track whether an electronic funds transfer had been completed as requested and/or whether a check had been issued, mailed and cleared as requested. In the latter example, the billee may even be able to view an image of the cancelled check through the billee's bank payment system 20 based upon the transaction number. A third party, such as the biller for the invoice, may be given similar access to see that payment was requested and to track the status of the requested payment.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method of processing payment of an invoice received by a billee, comprising:
receiving an electronic image of said invoice and payment information relating to said invoice from said billee, said payment information including a payment amount to be paid against said invoice;
generating a signed payment data element, said signed payment data element comprising a first portion including said electronic image of said invoice, at least a portion of said payment information including at least said payment amount, and OCR data obtained from said electronic image of said invoice through optical character recognition, and a second portion including a digital signature of said first portion generated using a private key of a payment system of a bank of said billee; and
transmitting said signed payment data element to said billee.

2. The method according to claim 1, further comprising storing said signed payment data element for subsequent access by said payment system.

3. The method according to claim 1, further comprising generating a transaction identifier after said receiving step, said transaction identifier being associated with said invoice, wherein said first portion further includes said transaction identifier.

4. The method according to claim 1, wherein said OCR data includes a name and address of a biller associated with said invoice and an amount due for said invoice.

5. The method according to claim 1, wherein said receiving step further comprises receiving said OCR data from said billee.

6. The method according to claim 1, further comprising generating said OCR data at said payment system following said receiving step and prior to said step of generating a signed payment data element.

7. The method according to claim 1, wherein said payment information further includes a method of payment for said invoice and wherein said first portion includes said method of payment.

8. The method according to claim 1, wherein said payment information further includes an identifier of a person authorized by said billee to make a payment for said invoice and wherein said first portion includes said identifier.

9. The method according to claim 1, wherein said payment information and said first portion further includes one or more of a method of payment for the invoice, an identifier of a person authorized by the billee to make a payment for the invoice, a transmission date and/or time associated with a transmission of said image, a terminal ID for a scanning device that generated said image, a location identifier of the scanning device, the TCP/IP address used by the scanning device, and a telephone number used by the scanning device.

10. The method according to claim 1, further comprising causing a payment to be made to a biller associated with said invoice.

11. The method according to claim 10, wherein said step of causing a payment to be made to said biller comprises one of causing an electronic funds transfer to be made to said biller, causing a check to be sent to said biller, and causing a credit card charge to be credited to said biller.

12. The method according to claim 1, wherein said transmitting step comprises transmitting said signed payment data element to said billee in a machine readable form that may be physically associated with said invoice.

13. The method according to claim 12, wherein said machine readable form comprises a barcode that may be printed on said invoice.

14. The method according to claim 1, further comprising determining whether said billee has sufficient funds to make a payment to a biller associated with said invoice in an amount equal to said payment amount, wherein said generating and transmitting steps are performed only if it is determined that said billee has said sufficient funds.

15. A method of arranging payment of an invoice received by a billee, comprising:
generating an electronic image of said invoice;
transmitting at least said electronic image and payment information relating to said invoice to a payment system of a bank of said billee, said payment information including a payment amount to be paid against said invoice;
receiving a signed payment data element from said payment system, said signed payment data element comprising a first portion including said electronic image of said invoice, at least a portion of said payment information including at least said payment amount, and OCR data obtained from said electronic image of said invoice through optical character recognition, and a second portion including a digital signature of said first portion generated using a private key of said payment system; and
associating said signed payment data element with said invoice;
wherein said payment system causes a payment to be made to a biller associated with said invoice in an amount equal to said payment amount.

16. The method according to claim 15, wherein said associating step comprising printing said signed payment data element on said invoice.

17. The method according to claim 16, wherein said receiving step comprises receiving said signed payment data element in a machine readable form and wherein said printing step comprises printing said signed payment data element in said machine readable form on said invoice.

18. The method according to claim 17, wherein said machine readable form comprises a barcode.

19. The method according to claim 15, further comprising generating said OCR data from said electronic image at a billee location, wherein said transmitting step further comprises transmitting said OCR data from said billee location to said payment system.

20. The method according to claim 15, wherein said OCR data is generated by said payment system from said electronic image.

21. The method according to claim 15, wherein said first portion further includes a transaction identifier associated with said invoice, said transaction being generated by said payment system following receipt of said electronic image and said payment information from said billee.

22. The method according to claim 15, wherein said OCR data includes a name and address of said biller associated with said invoice and an amount due for said invoice.

23. The method according to claim 15, wherein said payment information further includes a method of payment for said invoice and wherein said first portion includes said method of payment.

24. The method according to claim 15, further comprising securely logging into a scanning device by providing an identifier of a person authorized by said billee to make a payment for said invoice, wherein said scanning device is used to perform said generating step, and wherein said payment information and said first portion further include said identifier.

25. The method according to claim 15, wherein said payment information and said first portion further includes one or more of a method of payment for the invoice, an identifier of a person authorized by the billee to make a payment for the invoice, a transmission date and/or time associated with a transmission of said image, a terminal ID for a scanning device that generated said image, a location identifier of the scanning device, the TCP/IP address used by the scanning device, and a telephone number used by the scanning device.
